(19) United States
(12) Patent Application Publication
(10) Pub. No.: US 2016/0328946 A1
(43) Pub. Date: Nov. 10, 2016

(54) ALARM DEVICE AND ELECTRONIC DEVICE USING THE SAME

(71) Applicants: HONG FU JIN PRECISION INDUSTRY (ShenZhen) CO., LTD, Shenzhen (CN); HON HAI PRECISION INDUSTRY CO., LTD, New Taipei (TW)

(72) Inventor: SONG MA, Shenzhen (CN)

(21) Appl. No.: 14/754,219

(22) Filed: Jun. 29, 2015

(30) Foreign Application Priority Data
May 8, 2015 (CN) 201510231477.5

(51) Int. Cl. G08B 21/18

(52) U.S. Cl. CPC G08B 21/182

(57) ABSTRACT

A device to issue an alarm when an operating voltage is below or above a set range includes a detecting circuit, a processing circuit, and a warning circuit. The detecting circuit has first and second predetermined voltages preset and an operating voltage is read from an electronic component. The operating voltage is compared with the set range and the result of comparison is transmitted to the processing circuit. The processing circuit outputs a control signal to the warning circuit according to the comparison signal and the warning circuit outputs warning information. An electronic device including the alarm device is also provided.

### FIELD

The subject matter herein generally relates to indicator circuits and alarms.

### BACKGROUND

There are many electronic components in a computer. If an operating voltage of any one of the electronic components is not in a normal range, the computer may not operate properly. Therefore, whether an operating voltage of each electronic component is in a normal range should be known.

### BRIEF DESCRIPTION OF THE DRAWINGS

Implementations of the present technology will now be described, by way of example only, with reference to the attached figures.

FIG. 1 is a block diagram of an embodiment of an electronic device of the present disclosure, the electronic device comprising an alarm device.

FIG. 2 is a block diagram of an embodiment of the alarm device of FIG. 1, the alarm device comprising a control unit.

FIG. 3 is a block diagram of an embodiment of the control unit of FIG. 2.

FIG. 4 is a circuit diagram of a first embodiment of the control unit of FIG. 3.

FIG. 5 is a circuit diagram of a second embodiment of the control unit of FIG. 3.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections.

The connection can be such that the objects are permanently connected or releasably connected. The term “comprising” means “including, but not necessarily limited to”; it specifically indicates open-ended inclusion or membership in a so-described combination, group, series and the like.

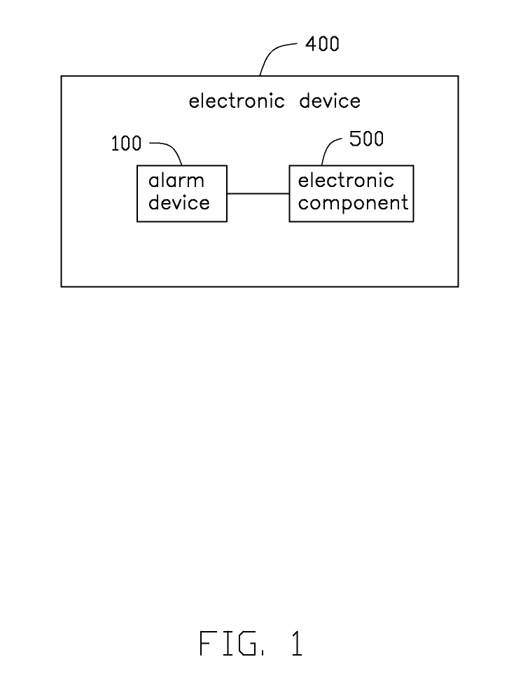

FIG. 1 illustrates an embodiment of an electronic device 400 of the present disclosure. The electronic device 400 can comprise an alarm device 100. The alarm device 100 is electrically coupled to an electronic component 500 of the electronic device 400, to obtain an operating voltage of the electronic component 500. In at least one embodiment, the electronic component 500 can be a central processing unit.

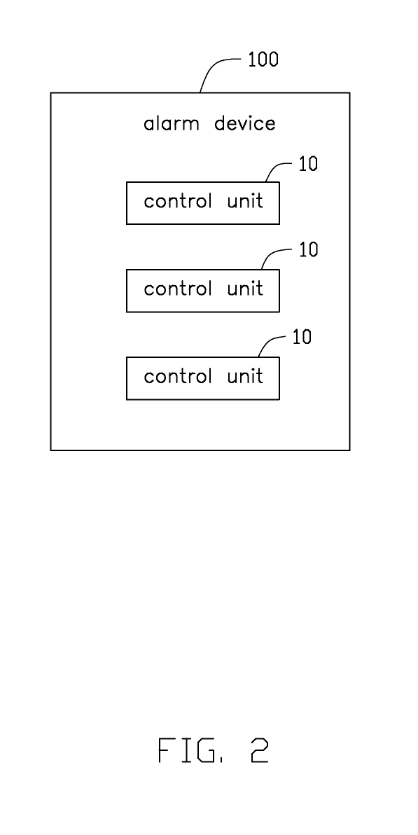

FIG. 2 illustrates an embodiment of the alarm device 100. The alarm device 100 can comprise a plurality of control units 10.

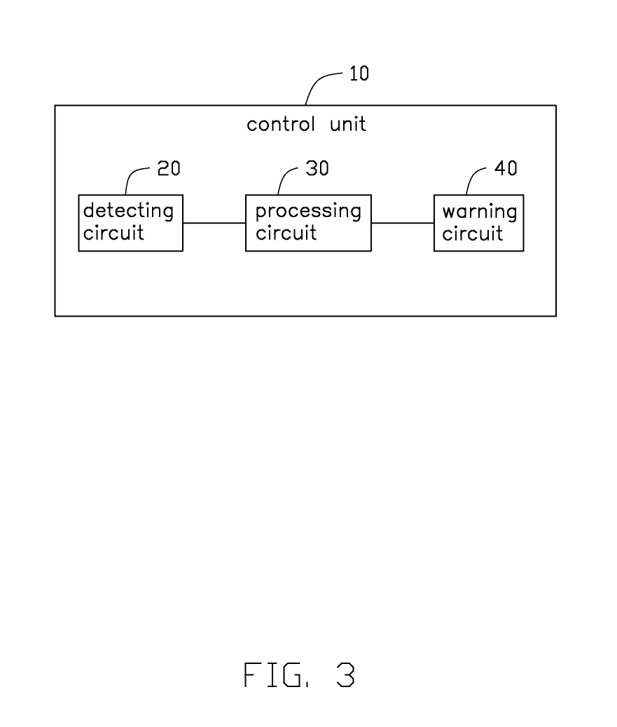

FIG. 3 illustrates an embodiment of the control unit 10. The control unit 10 can comprise a detecting circuit 20, a processing circuit 30, and a warning circuit 40. Both the detecting circuit 20 and the warning circuit 40 are electrically coupled to the processing circuit 30.

In at least one embodiment, the detecting circuit 20 is configured to have a first predetermined voltage and a second predetermined voltage set therein to obtain the operating voltage of the electronic component 500. The operating voltage so obtained is compared with the first predetermined voltage and the second predetermined voltage, and a comparison signal is output to the processing circuit 30 according to the result of comparison.

In at least one embodiment, the processing circuit 30 outputs a control signal to the warning circuit 40 according to the comparison signal transmitted by the detecting circuit 20.

In at least one embodiment, the warning circuit 40 outputs a warning information according to the control signal transmitted by the processing circuit 30.

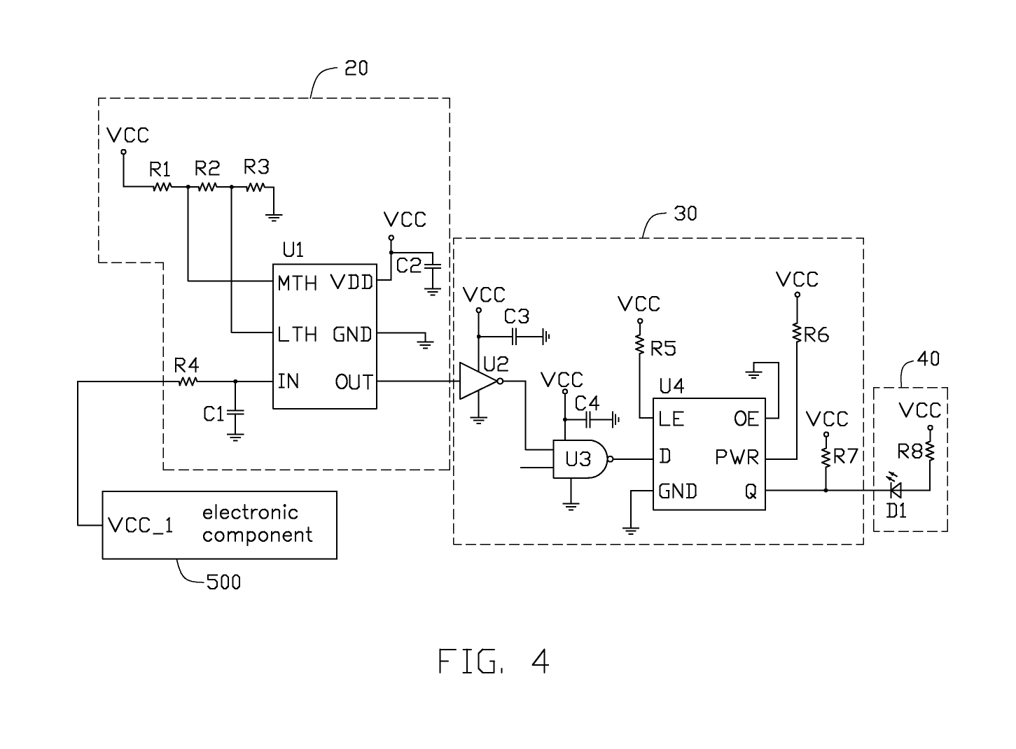

FIG. 4 illustrates a first embodiment of the control unit 10. The detecting circuit 20 can comprise a control chipset U1, four resistors R1-R4, and two capacitors C1 and C2. A first voltage pin MTH of the control chipset U1 is electrically coupled to a power supply VCC through the resistor R1, and is electrically coupled to ground through two resistors R2 and R3. A second voltage pin LTH of the control chipset U1 is electrically coupled to a node between the resistor R2 and the resistor R3. A detecting pin IN of the control chipset U1 is electrically coupled to ground through the capacitor C1, and is electrically coupled to a voltage terminal VCC_1 of the electronic component 500 through the resistor R4, to obtain the operating voltage from the electronic component 500. A power supply pin VDD of the control chipset U1 is electrically coupled to the power supply VCC, and is electrically coupled to ground through the capacitor C2. A ground pin GND of the control chipset U1 is electrically coupled to ground. A signal output pin OUT of the control chipset U1 is electrically coupled to the processing circuit 30, to output the comparison signal to the processing circuit 30.

The relationship between the first predetermined voltage V1 of the first voltage pin MTH of the control chipset U1, a voltage V of the power supply VCC, and resistance of the three resistors R1-R3 is shown below:

V1=V×(R2+R3)/(R1+R2+R3).

The relationship between the second predetermined voltage V2 of the second voltage pin LTH of the control chipset U1, the voltage V of the power supply VCC, and resistance of the three resistors R1-R3 is shown below:

V2=V×(R3)/(R1+R2+R3).

If the resistances of the resistors R1-R3 change, the first voltage V1 of the first voltage pin MTH of the control chipset U1 and the second voltage V2 of the second voltage pin LTH of the control chipset U1 change accordingly.

The processing circuit 30 can comprise a Schmidt trigger U2, a NAND gate U3, an inverting trigger U4, two capacitors C3 and C4, and three resistors R5-R7. An input terminal of the Schmidt trigger U2 is electrically coupled to the signal output pin OUT of the control chipset U1, to receive the comparison signal from the control chipset U1. A power supply terminal of the Schmidt trigger U2 is electrically coupled to the power supply VCC, and is electrically coupled to ground through the capacitor C3. A ground terminal of the Schmidt trigger U2 is electrically coupled to ground. An output terminal of the Schmidt trigger U2 is electrically coupled to a first input terminal of the NAND gate U3. A second input terminal of the NAND gate U3 is floating. A power supply terminal of the NAND gate U3 is electrically coupled to the power supply VCC, and is electrically coupled to ground through the capacitor C4. A ground terminal of the NAND gate U3 is electrically coupled to ground. An output terminal of the NAND gate U3 is electrically coupled to a data input pin D of the inverting trigger U4. A latch enable input pin LE of the inverting trigger U4 is electrically coupled to the power supply VCC through the resistor R5. A ground pin GND of the inverting trigger U4 is electrically coupled to ground. A power supply pin PWR of the inverting trigger U4 is electrically coupled to the power supply VCC through the resistor R6. An enable input pin OE of the inverting trigger U4 is electrically coupled to ground. A latch output pin Q of the inverting trigger U4 is electrically coupled to the power supply VCC through the resistor R7, and is electrically coupled to the warning circuit 40, to output the control signal to the warning circuit 40.

The warning circuit 40 can comprise a light emitting diode (LED) D1 and a resistor R8. A cathode of the LED D1 is electrically coupled to the latch output pin Q of the inverting trigger U4, to obtain the control signal from the inverting trigger U4. An anode of the LED D1 is electrically coupled to the power supply VCC through the resistor R8.

When the second input terminal of the NAND gate U3 is floating, based on the basic logic circuit principle, the logic level state of the second input terminal of the NAND gate U3 is at a high level, such as logic 1.

When the operating voltage of the electronic component 500 detected by the detecting pin IN of the control chipset U1 is between the first predetermined voltage V1 and the second predetermined voltage V2, the signal output pin OUT of the control chipset U1 outputs a comparison signal at a low level, to the input terminal of the Schmidt trigger U2. The Schmidt trigger U2 outputs a trigger signal at a high level to the first input terminal of the NAND gate U3. Thus, the output terminal of the NAND gate U3 outputs a signal at a low level to the data input pin D of the inverting trigger U4.

The latch output pin Q of the inverting trigger U4 outputs the control signal at a high level to turn off the LED D1. The LED D1 is not lit, indicating that the operating voltage of the electronic component 500 is within a normal range.

When the operating voltage of the electronic component 500 detected by the detecting pin IN of the control chipset U1 is not between the first predetermined voltage V1 and the second predetermined voltage V2, the signal output pin OUT of the control chipset U1 outputs the comparison signal at the high level to the input terminal of the Schmidt trigger U2. The Schmidt trigger U2 outputs a trigger signal at low level to the first input terminal of the NAND gate U3. Thus, the output terminal of the NAND gate U3 outputs a signal at the high-voltage level to the data input pin D of the inverting trigger U4. The latch output pin Q of the inverting trigger U4 outputs the control signal at the low level to turn on the LED D1. The LED D1 is lit, indicating that the operating voltage of the electronic component 500 is outside the normal range.

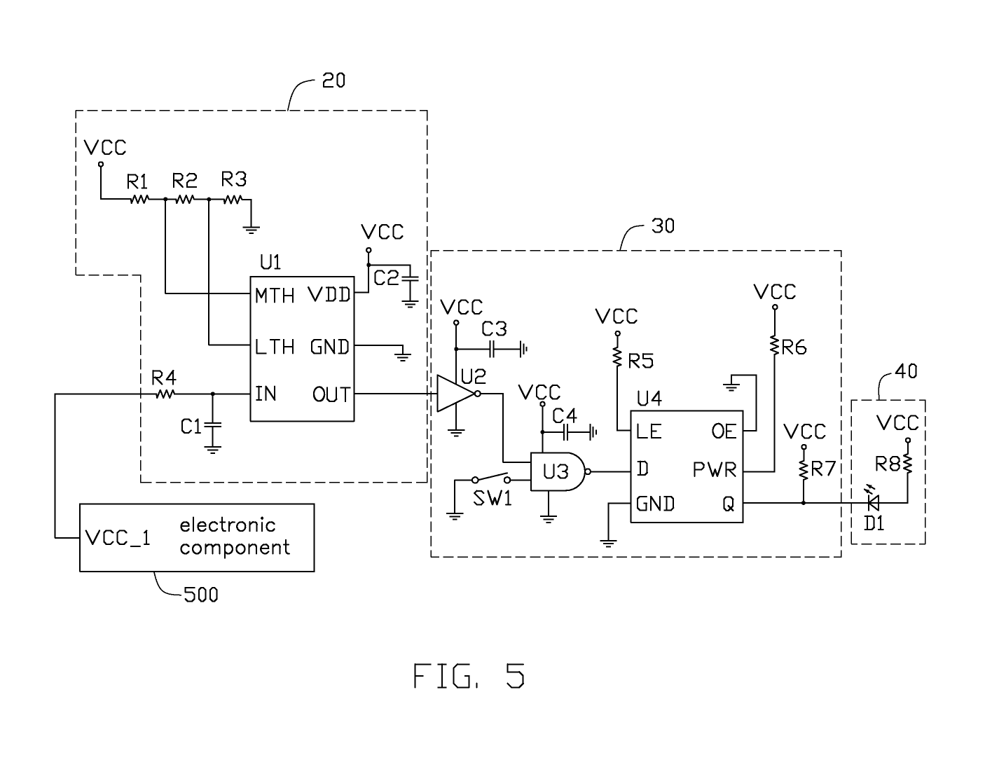

FIG. 5 illustrates a second embodiment of the control unit 10. The processing circuit 30 further comprises a switch SW1. A first terminal of the switch SW1 is electrically coupled to the second input terminal of the NAND gate U3. A second terminal of the switch SW1 is electrically coupled to ground.

When the switch SW1 is turned on, the second input terminal of the NAND gate U3 is electrically coupled to ground through the switch SW1 and the logic level of the second input terminal of the NAND gate U3 is at a low level, such as logic 0. At this time, the Schmidt trigger U2 outputs the trigger signal at either a high level or at a low level to the first input terminal of the NAND gate U3 and the output terminal of the NAND gate U3 outputs the signal at the low level to the data input pin D of the inverting trigger U4. The latch output pin Q of the inverting trigger U4 outputs the control signal at the high level to turn off the LED D1. As detailed above, if switch SW1 is turned on, the warning circuit 40 is turned off. Thus, regardless of whether the operating voltage of the electronic component 500 is within the normal range or not, the LED D1 is not lit, and the alarm function of the control unit 10 is turned off.

When the switch SW1 is turned off, the second input terminal of the NAND gate U3 is floating, and the operation principle of the control unit 10 in the second embodiment is then the same as in the first embodiment, and is not repeated here.

The embodiments shown and described above are only examples. Many details are often found in the art such as the other features of an electronic device. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. An alarm device comprising:
a detecting circuit configured for setting a first predetermined voltage and a second predetermined voltage, and obtaining an operation voltage from an electronic component, and comparing the operation voltage with the first predetermined voltage and the second predetermined voltage to obtain a comparison result, and outputting a comparison signal according to the comparison result;
a processing circuit configured for obtaining the comparison signal from the detecting circuit, and outputting a control signal according to the comparison signal;
a warning circuit configured for obtaining the control signal from the processing circuit, and outputting a warning information according to the control signal.

2. The alarm device of claim 1, wherein when the operation voltage of the electronic component detected by the detecting circuit is between the first predetermined voltage and the second predetermined voltage, the detecting circuit outputs the comparison signal at a low level to the processing circuit, the processing circuit outputs a control signal at a high level to the warning circuit according to the comparison signal at the low level outputted by the detecting circuit, the warning circuit outputs a first warning information according to the control signal at a high level outputted by the processing circuit.

3. The alarm device claim 2, wherein when the operation voltage of the electronic component detected by the detecting circuit is not between the first predetermined voltage and the second predetermined voltage, the detecting circuit outputs the comparison signal at a high level to the processing circuit, the processing circuit outputs a control signal at a low level to the warning circuit according to the comparison signal at the high level outputted by the detecting circuit, the warning circuit outputs a second warning information according to the control signal at a low level outputted by the processing circuit.

4. The alarm device of claim 3, wherein the detecting circuit comprises a control chipset, first to fourth resistors, a first capacitor and a second capacitor, the control chipset comprises a first voltage pin, a second voltage pin, a detecting pin, a power supply pin, a ground pin, and a signal output pin, the first voltage pin of the control chipset is electrically coupled to a power supply through the first resistor, and is electrically coupled to a ground through the second resistor and the third resistor, the second voltage pin of the control chipset is electrically coupled to a node between the second resistor and the third resistor, the detecting pin of the control chipset is electrically coupled to the ground through the first capacitor, and is electrically coupled to a voltage terminal of the electronic component through the fourth resistor, to obtain the operation voltage from the electronic component, the power supply pin of the control chipset is electrically coupled to the power supply, and is electrically coupled to the ground through the second capacitor, the ground pin of the control chipset is electrically coupled to ground, the signal output pin of the control chipset is electrically coupled to processing circuit, to output the comparison signal to the processing circuit.

5. The alarm circuit of claim 4, wherein the processing circuit comprises a Schmidt trigger, a NAND gate, an inverting trigger, a third capacitor, a fourth capacitor, and fifth to seventh resistors, the Schmidt trigger comprises an input terminal, a power supply terminal, a ground terminal, and an output terminal, the NAND gate comprises a first input terminal, a second input terminal, a power supply terminal, a ground terminal, and an output terminal, the inverting trigger comprises a data input pin, a latch enable input pin, a ground pin, a power supply pin, an enable input pin, and a latch output pin, the input terminal of the Schmidt trigger is electrically coupled to the signal output pin of the control chipset, to receive the comparison signal from the control chipset, the power supply terminal of the Schmidt trigger is electrically coupled the power supply, and is electrically coupled to the ground through the third capacitor, the ground terminal of the Schmidt trigger is electrically coupled to the ground, the output terminal of the Schmidt trigger is electrically coupled to the first input terminal of the NAND gate, the second input terminal of the NAND gate is floating, the power supply terminal of the NAND gate is electrically coupled to the power supply, and is electrically coupled to ground through the fourth capacitor, the ground terminal of the NAND gate is electrically coupled to the ground, the output terminal of the NAND gate is electrically coupled to the data input pin of the inverting trigger, the latch enable input pin of the inverting trigger is electrically coupled to the power supply through the fifth resistor, the ground pin of the inverting trigger is electrically coupled to the ground, the power supply pin of the inverting trigger is electrically coupled to first the power supply through the sixth resistor, the enable input pin of the inverting trigger is electrically coupled to the ground, the latch output pin of the inverting trigger is electrically coupled to the power supply through the seventh resistor, and is electrically coupled to the warning circuit, to output the control signal to the warning circuit.

6. The alarm circuit of claim 5, wherein the processing circuit further comprises a switch, the switch comprises a first terminal and a second terminal, the first terminal of the switch is electrically coupled to the second input terminal of the NAND gate, the second terminal of the switch is electrically coupled to the ground, when the switch is turned on, the second input terminal of the NAND gate is electrically coupled to the ground through the switch, the processing circuit outputs a control signal at a high level to the warning circuit, the warning circuit outputs the second warning information according to the control signal at the high level outputted by the processing circuit.

7. An electronic device comprising:
an electronic component;
a control unit comprising:
a detecting circuit configured for setting a first predetermined voltage and a second predetermined voltage, and obtaining an operation voltage from the electronic component, and comparing the operation voltage with the first predetermined voltage and the second predetermined voltage, to obtain a comparison result, and outputting a comparison signal according to the comparison result;
a processing circuit configured for obtaining the comparison signal from the detecting circuit, and outputting a control signal according to the comparison signal;
a warning circuit configured for obtaining the control signal from the processing circuit, and outputting a warning information according to the control signal.

8. The electronic device of claim 7, wherein when the operation voltage of the electronic component detected by the detecting circuit is between the first predetermined voltage and the second predetermined voltage, the detecting circuit outputs the comparison signal at a low level to the processing circuit, the processing circuit outputs a control signal at a high level to the warning circuit according to the comparison signal at the low level outputted by the detecting circuit, the warning circuit outputs a first warning information according to the control signal at a high level outputted by the processing circuit.

9. The electronic device of claim 8, wherein when the operation voltage of the electronic component detected by the detecting circuit is not between the first predetermined voltage and the second predetermined voltage, the detecting circuit outputs the comparison signal at a high level to the processing circuit, the processing circuit outputs a control signal at a low level to the warning circuit according to the comparison signal at the high level outputted by the detecting circuit, the warning circuit outputs a second warning information according to the control signal at a low-voltage level outputted by the processing circuit.

10. The electronic device of claim 9, wherein the detecting circuit comprises a control chipset, first to fourth resistors, a first capacitor and a second capacitor, the control chipset comprises a first voltage pin, a second voltage pin, a detecting pin, a power supply pin, a ground pin, and a signal output pin, the first voltage pin of the control chipset is electrically coupled to a power supply through the first resistor, and is electrically coupled to a ground through the second resistor and the third resistor, the second voltage pin of the control chipset is electrically coupled to a node between the second resistor and the third resistor, the detecting pin of the control chipset is electrically coupled to the ground through the first capacitor, and is electrically coupled to a voltage terminal of the electronic component through the fourth resistor, to obtain the operation voltage from the electronic component, the power supply pin of the control chipset is electrically coupled to the power supply, and is electrically coupled to the ground through the second capacitor, the ground pin of the control chipset is electrically coupled to ground, the signal output pin of the control chipset is electrically coupled to processing circuit, to output the comparison signal to the processing circuit.

11. The electronic device of claim 10, wherein the processing circuit comprises a Schmidt trigger, a NAND gate, an inverting trigger, a third capacitor, a fourth capacitor, and fifth to seventh resistors, the Schmidt trigger comprises an input terminal, a power supply terminal, a ground terminal, and an output terminal, the NAND gate comprises a first input terminal, a second input terminal, a power supply terminal, a ground terminal, and an output terminal, the inverting trigger comprises a data input pin, a latch enable input pin, a ground pin, a power supply pin, an enable input pin, and a latch output pin, the input terminal of the Schmidt trigger is electrically coupled to the signal output pin of the control chipset, to receive the comparison signal from the control chipset, the power supply terminal of the Schmidt trigger is electrically coupled the power supply, and is electrically coupled to the ground through the third capacitor, the ground terminal of the Schmidt trigger is electrically coupled to the ground, the output terminal of the Schmidt trigger is electrically coupled to the first input terminal of the NAND gate, the second input terminal of the NAND gate is floating, the power supply terminal of the NAND gate is electrically coupled to the power supply, and is electrically coupled to ground through the fourth capacitor, the ground terminal of the NAND gate is electrically coupled to the ground, the output terminal of the NAND gate is electrically coupled to the data input pin of the inverting trigger, the latch enable input pin of the inverting trigger is electrically coupled to the power supply through the fifth resistor, the ground pin of the inverting trigger is electrically coupled to the ground, the power supply pin of the inverting trigger is electrically coupled to first the power supply through the sixth resistor, the enable input pin of the inverting trigger is electrically coupled to the ground, the latch output pin of the inverting trigger is electrically coupled to the power supply through the seventh resistor, and is electrically coupled to the warning circuit, to output the control signal to the warning circuit.

12. The electronic device of claim 11, wherein the processing circuit further comprises a switch, the switch comprises a first terminal and a second terminal, the first terminal of the switch is electrically coupled to the second input terminal of the NAND gate, the second terminal of the switch is electrically coupled to the ground, when the switch is turned on, the second input terminal of the NAND gate is electrically coupled to the ground through the switch, the processing circuit outputs a control signal at a high level to the warning circuit, the warning circuit outputs the second warning information according to the control signal at the high level outputted by the processing circuit.

13. An alarm, comprising:
a voltage divider configured to divide a power supply voltage into first and second reference voltages that are non-zero;
a detector circuit configured to receive the first and second reference voltages, and to receive an operating voltage of an electronic component, the detector circuit being configured to issue a first control signal, the first control signal having a first value in response to the operating voltage being with a range between the first and second reference voltages, and the first control signal having a second value responsive to the operating voltage being outside the range;
a processing circuit configured to receive the first control signal, and for outputting a second control signal containing warning content to a warning circuit, the processing circuit including at least a Schmidt trigger configured to receive the first control signal, and a NAND gate having a first input terminal configured to receive the output of the Schmitt trigger.

14. The alarm of claim 13, wherein the NAND gate has a second input terminal that is connected to a short circuit that is floating.

15. The alarm of claim 13, wherein the NAND gate has a second input terminal that is selectively connectable to ground and short circuit that is floating.
